(19) United States
(12) Patent Application Publication
(10) Pub. No.: US 2006/0020567 A1
(43) Pub. Date: Jan. 26, 2006

(54) Method for message browsing

(76) Inventors: Li Li, Shanghai (CN); Tai-Shui Ho, Shanghai (CN); Shih-Kuang Tsai, Shanghai (CN)

Correspondence Address: BIRCH STEWART KOLASCH & BIRCH, PO BOX 747, FALLS CHURCH, VA, 22040-0747, US

(21) Appl. No.: 10/898,168

(22) Filed: Jul. 26, 2004

(51) Int. Cl. G06F 17/00

(52) U.S. Cl. 706/50

(57) ABSTRACT

A method for message browsing. Functional parameters of “inquiry by username (or phone number)” and “inquiry by keyword” are added to a menu list. Next, one parameter is determined, to locate a desired message by inputting a search term, such as a name, phone number, or keyword. Finally, contents of located messages or a failure response are displayed.

### BACKGROUND

The present invention relates to a browsing method, and in particular to a method for rapid message browsing.

With cell phone message storage capacity increasing, manipulation of only directional keys to browse becomes inconvenient.

Messages can be searched using a name or phone number of the sender. If there is only one message from the sender, arrow key use can locate the message although much time may be required if numerous messages are stored. In addition, if multiple messages are stored from the sender, individual review of messages is required, costing even more time and effort.

In another method, messages can be searched according to a keyword. This method can require as much or more inconvenience as the first.

### SUMMARY

An embodiment of the invention thus provides a method for rapid message browsing, in which an inquiry option is added to a menu list, comprising two functional parameters of “inquiry by username (or phone number)” and “inquiry by keyword”, and a flag i is defined for conditional determination.

First, one parameter is determined, using a name, phone number, or keyword to search messages. A searching term (the name, phone number, or keyword) is input using the keyboard and the value of the flag i is set to one. Next, it is determined whether the search term corresponds to the i-th message (the first message, i=1 at present), and, if so, contents of the i-th message are displayed. It is then determined whether the located message is the desired message. If so, the search process concludes, and, if not, the search process continues. If no corresponding message is located, the value of the flag i is increased by one, and the search process proceeds to search the next message.

A detailed description is given in the following with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a flowchart showing the method for message browsing according to an embodiment of the invention, in which messages are searched using a name or phone number; and

FIG. 2 is a flowchart showing the method for message browsing according to an embodiment of the invention, in which messages are searched using a keyword.

### DETAILED DESCRIPTION

An embodiment of the invention discloses a method for rapid message browsing. An inquiry option is added to a message list, comprising two functional parameters of “inquiry by username (or phone number)” and “inquiry by keyword”. In an example, the message list includes ten messages and a flag i is defined for conditional determination.

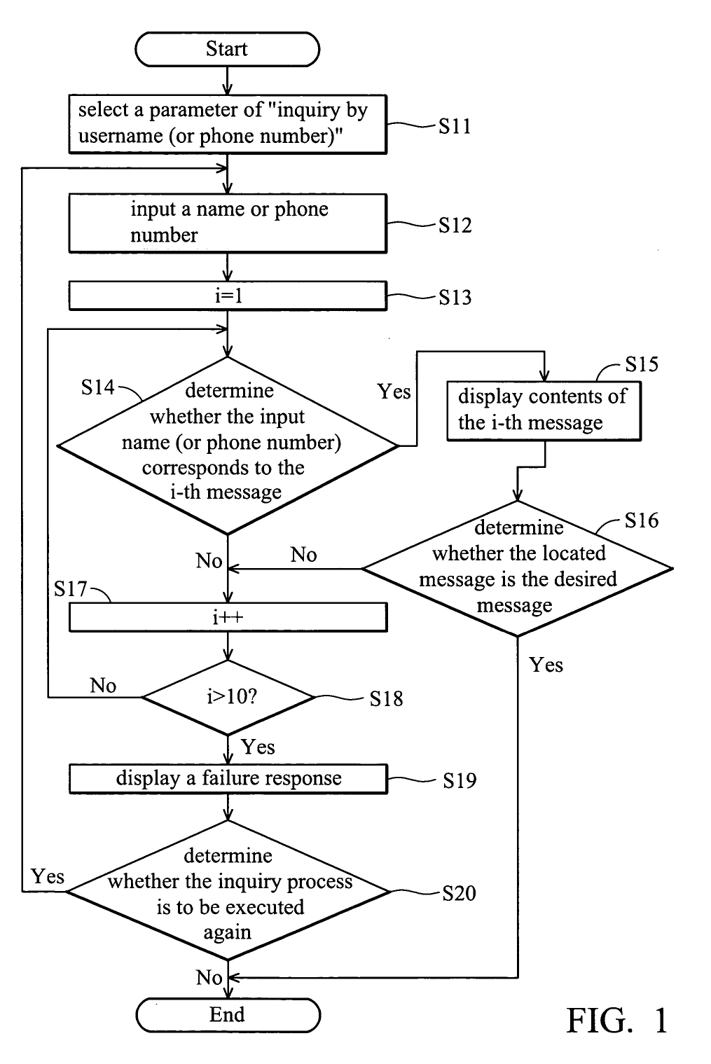

FIG. 1 is a flowchart showing the method for message browsing according to an embodiment of the invention, in which messages are searched using a name or phone number.

In step S11, the functional parameter of “inquiry by username (or phone number)” is determined to locate a desired message.

In step S12, a name or phone number is input. A message, for example, whose content is “This is John, please join my birthday party on May 24” is sought. If data has stored in an address book, the name or phone number can be directly accessed therefrom.

In step S13, the value of the flag i is set to one, indicating the search process starts at the first stored message.

In step S14, it is determined whether the input name or phone number corresponds to the name or phone number of the i-th message (the first message at present). If so, the process goes to step S15, and, if not, to step S17.

In step S15, if a corresponding message is located and contents thereof are displayed.

In step S16, it is determined whether the located message is the desired message. If so, the process concludes, and, if not, to step S17.

In step S17, the value of the flag i is added one.

In step S18, it is determined whether the value of the flag i exceeds a predetermined number, ten in the example. If so, the process goes to step S19, and, if not, to step S14, executing search term determination for the next message.

In step S19, if the value of the flag i exceeds the number of stored messages, a failure response is generated, indicating the desired message cannot be located.

In step S20, it is determined whether the inquiry process is to be executed again. If so, the process goes to step S12, and, if not, the process concludes.

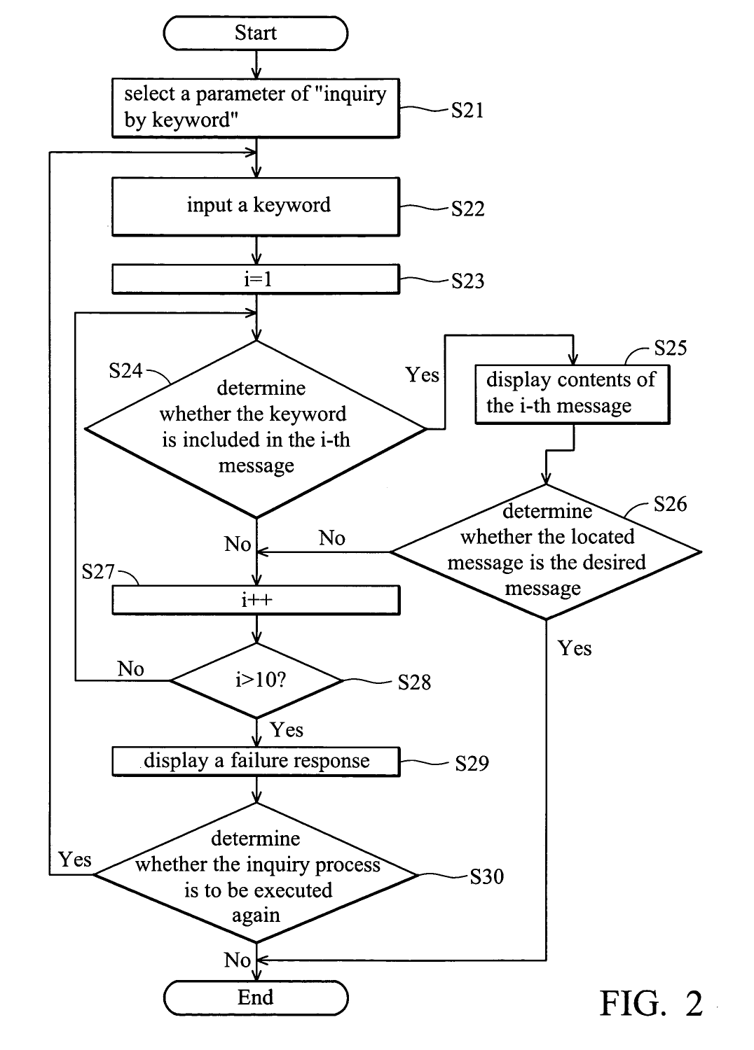

FIG. 2 is a flowchart showing the method for message browsing according to an embodiment of the invention, in which messages are searched using a keyword.

In step S21, the functional parameter of “inquiry by keyword” is determined to search a desired message.

In step S22, a keyword is input. The character “party” is token for the keyword

In step S23, the value of the flag i is set to one, indicating the search process begins at the first stored message.

In step S24, it is determined whether the keyword is included in the i-th message (the first message at the example). If so, the process goes to step S15, and, if not, to step S17.

In step S25, if a corresponding message is located, contents thereof are displayed.

In step S26, it is determined whether the located message is the desired message. If so, the process concludes, and, if not, to step S17.

In step S27, the value of the flag i is increased by one.

In step S28, it is determined whether the value of the flag i exceeds a predetermined number, ten in the example. If so, the process goes to step S19, and, if not, to step S14, executing search term determination for the next message.

In step S29, if the value of the flag i exceeds the number of stored messages, a failure response is generated, indicating the desired message cannot be located.

In step S30, it is determined whether the inquiry process is to be executed again. If so, the process goes to step S12, and, if not, the process concludes.

While the invention has been described by way of example and in terms of preferred embodiment, it is to be understood that the invention is not limited thereto.

What is claimed is:

1. A method for message browsing, comprising:
providing a message list, comprising a plurality of messages;
inputting inquiry data;
determining whether the inquiry data is included in the first message; and
repeating the determining step until a desired message containing the inquiry data is located.

2. The method as claimed in claim 1, wherein the inquiry data determination further comprises:
determining whether the inquiry data corresponds to contents of the first message;
displaying the contents of the first message if the inquiry data is included in the first message;
determining whether the first message is the desired message;
repeating the inquiry process if the inquiry data does not correspond to the contents of the first message, or if the first message is not the desired message; and
displaying a failure response if the desired message is not located.

3. The method as claimed in claim 1, wherein the inquiry data comprises Chinese or English characters or numbers.

4. The method as claimed in claim 1, wherein the inquiry data is a combination of Chinese and English characters and numbers.

5. A storage medium storing a computer program providing a method for message browsing, comprising using a computer to perform the steps of:
providing a message list, comprising a plurality of messages;
inputting inquiry data;
determining whether the inquiry data is included in the first message; and
repeating the determining step until a desired message containing the inquiry data is located.

6. The storage medium as claimed in claim 5, wherein comparison comprises:
determining whether the inquiry data corresponds to contents of the first message;
displaying the contents of the first message if the inquiry data is included in the first message;
determining whether the first message is the desired message;
repeating the inquiry process if the inquiry data does not correspond to the contents of the first message, or if the first message is not the desired message; and
displaying a failure response if the desired message is not located.

7. The storage medium as claimed in claim 5, wherein the inquiry data comprises Chinese or English characters or numbers.

8. The storage medium as claimed in claim 5, wherein the inquiry data is a combination of Chinese and English characters and numbers.
